(19) United States
(12) Patent Application Publication
(10) Pub. No.: US 2011/0157372 A1
(43) Pub. Date: Jun. 30, 2011

(54) MULTIMEDIA APPARATUS HAVING FUNCTION OF DETECTING VIDEO SIGNAL CONNECTION

(75) Inventors: Chao-Yung Liu, Hsinchu City (TW); Wei Wu, Zhubei City (TW); Chieh-Chien Huang, Hsinchu City (TW); Yi-Fu Chen, Hsinchu City (TW)

(73) Assignee: Sunplus Technology Co., Ltd., Hsinchu (TW)

(21) Appl. No.: 12/970,181

(22) Filed: Dec. 16, 2010

(30) Foreign Application Priority Data
Dec. 31, 2009 (TW) 98146506

(51) Int. Cl. H04N 17/00

(52) U.S. Cl. 348/180; 348/E17.001

(57) ABSTRACT

A multimedia apparatus has a function of detecting video signal connection. The multimedia apparatus includes plural video output terminals. The user may selectively connect one of the video output terminals with a TV set. The analog video signal outputted from the video output terminal is detected by a detector. In a case that the connection between the first video output terminal and the TV set is interrupted but the second video output terminal is connected with the TV set, the detector issues control signal. According to the control signal, a first digital-to-analog converter is disabled to stop outputting a first analog video signal through the first video output terminal, and a second digital-to-analog converter is enabled to output a second analog video signal through the second video output terminal.

This application claims the benefit of Taiwan application Serial No. 98146506, filed Dec. 31, 2009, the subject matter of which is incorporated herein by reference.

### FIELD OF THE INVENTION

The present invention relates to a multimedia apparatus, and more particularly to a multimedia apparatus having a function of detecting video signal connection.

### BACKGROUND OF THE INVENTION

Nowadays, a multimedia apparatus such as a game player or a media player is used to transmit video signals to a display device (e.g. a TV set) through a signal line. Since most of the current TV sets are designed to receive analog video signals, the multimedia apparatus should provide corresponding analog video signals to the TV sets.

Generally, the multimedia apparatus can simultaneously output various video signal formats in various applications. The standard formats of video signals provided by the multimedia apparatus include for example composite video broadcast signals (CVBS signals), separate video signals (S-Video signals), YUV signals, RGB signals, and the like. The S-Video signal consists of one luminance signal (Y signal) and one color signal (C signal). The YUV signal consists of one luminance signal (Y signal) or two chrominance signals (U and V signals). The RGB signal consists of a red signal (R signal), a green signal (G) and a blue signal (B). Generally, there are two kinds of RGB interfaces. In the first RGB interface, the RGB signal has a synchronous signal. For example, a synchronous signal is added to the green (G) signal (sync-on-green signal). The second RGB interface is a SCART interface that supports the RGB signal and the CVBS signal.

Since all of the controlling circuits of the multimedia apparatus are digital circuits, the multimedia apparatus should include a digital-to-analog converter (DAC) to convert digital video signals into analog video signals, which are then transmitted to the TV set.

In a case that the multimedia apparatus can simultaneously support various video signal formats, if the multimedia apparatus fails to realize which format of video signal is connected to the TV set, some problems occur. For example, after the multimedia apparatus is turned on, various analog video signals are normally outputted from all signal output terminals. As known, the way of outputting various analog video signals increases the burden of the digital-to-analog converter, and causes unnecessary power consumption of the multimedia apparatus.

For solving the above problems, an automatic load detection method is disclosed in for example US Patent Publication No. US2009/0158066, which is entitled “Power management using automatic load/unload detection of DAC”. According to this automatic load detection method, if it is determined that an analog video signal is not used, the DAC corresponding to the analog video signal is turned off. Since the DAC is turned off, even if the load is connected with the DAC again, this DAC fails to be turned on.

For example, a multimedia apparatus can output three formats of video signals, and a first video signal output terminal is in communication with the TV set through a signal line. After the multimedia apparatus is turned on, the detector of the multimedia apparatus may realize the connecting relationship between the first video signal and the TV set, and the

DACs corresponding to other video signals are turned off. However, once the multimedia apparatus is turned on, the connecting relationship between the first video signal and the TV set is determined and cannot to be changed again. Under this circumstance, after the multimedia apparatus is turned on, if the signal line between the first video signal output terminal and the TV set is pulled out and the signal is connected between a second first video signal output terminal and the TV set, the TV set fails to normally receive the second video signal.

### SUMMARY OF THE INVENTION

Therefore, the present invention provides a multimedia apparatus having a function of detecting video signal connection. By continuously detecting whether the connecting relationship between the video signal and the TV set is changed, the corresponding DAC is turned on or turned off. Consequently, the power-saving efficacy of the multimedia apparatus is achieved.

In accordance with an aspect, the present invention provides a multimedia apparatus. The multimedia apparatus includes a first video output terminal, a first resistor and a controlling circuit. The first video output terminal is used to be connected with a display device. The first resistor is interconnected between the first video output terminal and a ground terminal. The controlling circuit includes a digital video signal generator, a first digital-to-analog converter and a detector. The digital video signal generator is used for outputting a first digital video signal and a blanking interval indicating signal. The first digital-to-analog converter is used for receiving the first digital video signal. The first digital-to-analog converter has a control terminal for receiving a control signal. According to the control signal, the first digital-to-analog converter is enabled to convert the first digital video signal into a first analog video signal and transmit the first analog video signal to the first video output terminal. The detector is used for receiving the first analog video signal. During a detecting period and in response to an enabling state of the blanking interval indicating signal, the detector outputs the control signal to enable the first digital-to-analog converter and compares the first analog video signal with a threshold voltage to obtain a resulting signal. According to the resulting signal, the detector judges whether the first analog video signal is permitted to be transmitted to the display device or not. If the first analog video signal fails to be transmitted to the detector, the first digital-to-analog converter is disabled according to the control signal outputted from the detector. Whereas, if the first analog video signal is permitted to be transmitted to the display device, the first digital-to-analog converter is enabled according to the control signal outputted from the detector.

In accordance with another aspect, the present invention provides a multimedia apparatus. The multimedia apparatus includes a first video output terminal, a second video output terminal, a first resistor, a second resistor and a controlling circuit. The first video output terminal is used to be connected with a display device. The second video output terminal is used to be connected with the display device. The first resistor is interconnected between the first video output terminal and a ground terminal. The second resistor is interconnected between the second video output terminal and the ground terminal. The controlling circuit includes a digital video signal generator, a first digital-to-analog converter, a second digital-to-analog converter and a detector. The digital video signal generator is used for outputting a first digital video signal, a second digital video signal and a blanking interval indicating signal. The first digital-to-analog converter is used for receiving the first digital video signal. The first digital-to-analog converter has a first control terminal for receiving a control signal. According to the control signal, the first digital-to-analog converter is enabled to convert the first digital video signal into a first analog video signal and transmit the first analog video signal to the first video output terminal, or the first digital-to-analog converter is disabled to stop converting the first digital video signal into the first analog video signal. The second digital-to-analog converter is used for receiving the second digital video signal. The second digital-to-analog converter has a second control terminal for receiving the control signal. According to the control signal, the second digital-to-analog converter is enabled to convert the second digital video signal into a second analog video signal and transmit the second analog video signal to the second video output terminal, or the second digital-to-analog converter is disabled to stop converting the second digital video signal into the second analog video signal. The detector is used for receiving the first analog video signal and the second analog video signal. During a detecting period and in response to an enabling state of the blanking interval indicating signal, the detector outputs the control signal to enable the first digital-to-analog converter and compares the first analog video signal with a threshold voltage to obtain a resulting signal. According to the resulting signal, the detector judges whether the first analog video signal is permitted to be transmitted to the display device or not. If the first analog video signal fails to be transmitted to the detector, the first digital-to-analog converter is disabled according to the control signal outputted from the detector. Whereas, if the first analog video signal is transmitted to the display device again, the first digital-to-analog converter is re-enabled according to the control signal outputted from the detector.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic circuit diagram illustrating a connection detector for detecting a video signal in a multimedia apparatus according to an embodiment of the present invention;

FIG. 2 is a schematic timing waveform diagram illustrating a video signal;

FIG. 3 is a schematic timing waveform diagram illustrating the relationship between the frame of the video signal and the detecting period; and

FIG. 4 is a flowchart illustrating a method for detecting video signal connection of a multimedia apparatus according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

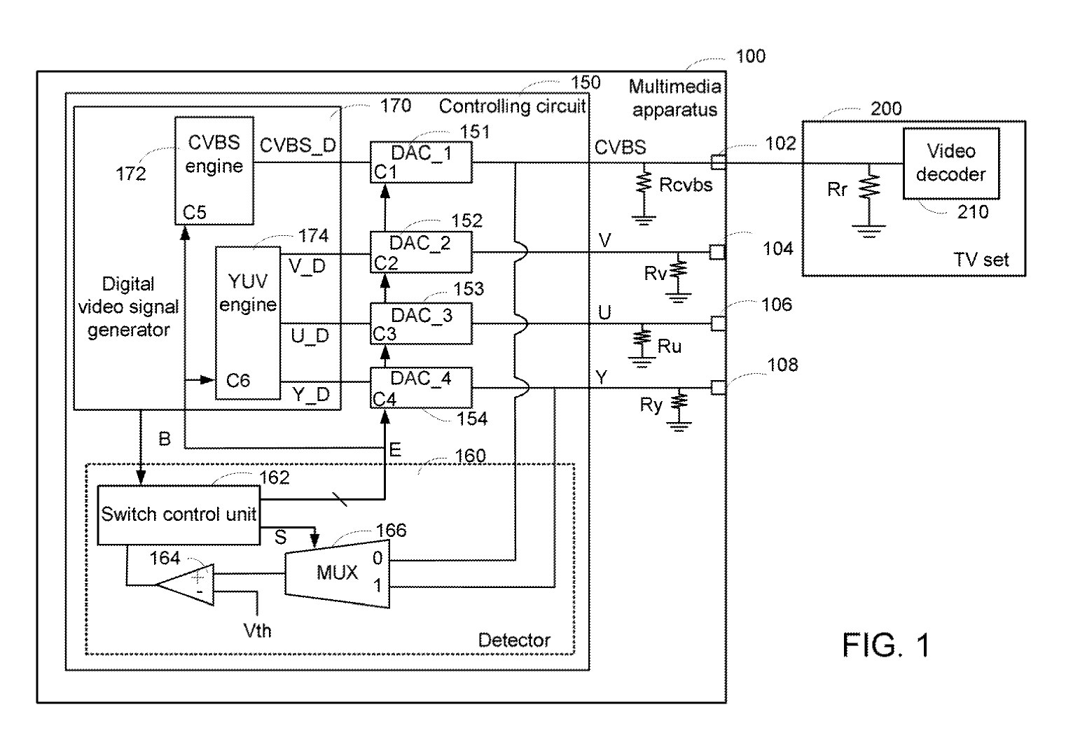

FIG. 1 is a schematic circuit diagram illustrating a multimedia apparatus having a function of detecting video signal connection according to an embodiment of the present invention. As shown in FIG. 1, the multimedia apparatus 100 comprises plural video output terminals 102, 104, 106, 108, a controlling circuit 150, and plural resistors Rcvbs, Rv, Ru, Ry. The multimedia apparatus 100 can simultaneously output a CVBS signal and a YUV signal to a TV set 200 through a signal line. The TV set 200 comprises a video decoder 210 and a receiving resistor Rr. The receiving resistor Rr is interconnected between an input terminal of the video decoder 210 and a ground terminal. By connecting the TV set 200 with the video output terminal 102 of the multimedia apparatus 100 through the signal line, the CVBS signal may be received by the TV set 200. The video decoder 210 is used to receive and decode the CVBS signal. According to the requirement specifications, the resistors Rcvbs, Rv, Ru, Ry of the multimedia apparatus 100 and the receiving resistor Rr of the video decoder 210 are all 75 ohms.

Moreover, the controlling circuit 150 of the multimedia apparatus 100 can output the CVBS signal and the YUV signal. The controlling circuit 150 is connected with the video output terminals 102, 104, 106, 108. The resistors Rcvbs, Rv, Ru, Ry are respectively interconnected between the video output terminals 102, 104, 106, 108 and the ground terminal. The controlling circuit 150 comprises a digital video signal generator 170, a detector 160, a first digital-to-analog converter (DAC_1) 151, a second digital-to-analog converter (DAC_2) 152, a third digital-to-analog converter (DAC_3) 153 and a fourth digital-to-analog converter (DAC_4) 154.

The digital video signal generator 170 comprises a CVBS engine 172 and a YUV engine 174. The CVBS engine 172 and the YUV engine 174 have respective control terminals C5 and C6. In a case that the control terminal C5 of the CVBS engine 172 is turned on, a digital CVBS signal CVBS_D is outputted from the CVBS engine 172 to the first digital-to-analog converter (DAC_1) 151. In a case that the control terminal C6 of the YUV engine 174 is turned on, a digital Y signal Y_D, a digital U signal U_D and a digital V signal V_D are outputted from the YUV engine 174 to the fourth digital-to-analog converter (DAC_4) 154, the third digital-to-analog converter (DAC_3) 153 and the second digital-to-analog converter (DAC_2) 152, respectively. On the other hand, in a case that the CVBS engine 172 is turned off, the digital CVBS signal CVBS_D is not outputted from the CVBS engine 172. In a case that the YUV engine 174 is turned off, the digital Y signal Y_D, the digital U signal U_D and the digital V signal V_D are not outputted from the YUV engine 174.

Moreover, the first digital-to-analog converter (DAC_1) 151, the second digital-to-analog converter (DAC_2) 152, the third digital-to-analog converter (DAC_3) 153 and the fourth digital-to-analog converter (DAC_4) 154 have respective control terminals C1˜C4. The control terminals C1˜C4 are respectively controlled by a control signal E. For example, in a case that the first digital-to-analog converter (DAC_1) 151 is turned on according to the control signal E, the digital CVBS signal CVBS_D is converted into an analog CVBS signal by the first digital-to-analog converter (DAC_1) 151. On the other hand, in a case that the first digital-to-analog converter (DAC_1) 151 is turned off according to the control signal E, the digital CVBS signal CVBS_D fails to be converted into the analog CVBS signal by the first digital-to-analog converter (DAC_1) 151.

In this embodiment, the detector 160 of the controlling circuit 150 comprises a switch control unit 162, a multiplexer 166 and a comparator 164. The switch control unit 162 is connected with the digital video signal generator 170 for receiving a blanking interval indicating signal (B) and issuing a select signal S to the multiplexer 166. The input terminal of the multiplexer 166 receives the CVBS signal and the Y signal. According to the select signal S, the multiplexer 166 selectively outputs either the CVBS signal or the Y signal. The input terminals of the comparator 164 are connected with the output terminal of the multiplexer 166 and a threshold voltage Vth. In addition, a resulting signal is outputted from the comparator 164 to the switch control unit 162. According to the resulting signal, the switch control unit 162 issues the control signal E to the first digital-to-analog converter (DAC_1) 151, the second digital-to-analog converter (DAC_2) 152, the third digital-to-analog converter (DAC_3) 153, the fourth digital-to-analog converter (DAC_4) 154, the CVBS engine 172 and the YUV engine 174. Take the connecting relationship between the multimedia apparatus 100 and the TV set 200 as shown in FIG. 1 for example. According to the control signal E outputted from the detector 160, the first digital-to-analog converter (DAC_1) 151 and the CVBS engine 172 are turned on, but the YUV engine 174, the second digital-to-analog converter (DAC_2) 152, the third digital-to-analog converter (DAC_3) 153, the fourth digital-to-analog converter (DAC_4) 154 are turned off.

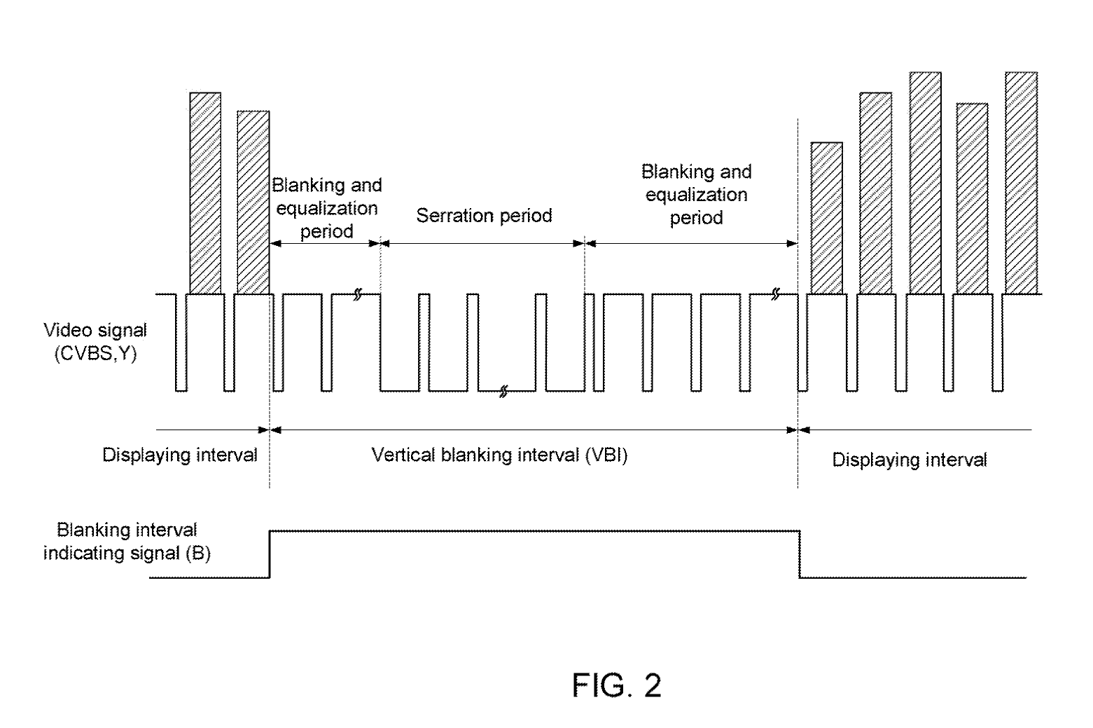

FIG. 2 is a schematic timing waveform diagram illustrating a video signal. Generally, a frame of the CVBS signal or the Y signal includes a displaying interval and a vertical blanking interval (VBI). In the vertical blanking interval, a blanking and equalization period, a serration period and a blanking and equalization period successively occur. In response to an enabling state of the blanking interval indicating signal (B), the video signal appears within the vertical blanking interval. Whereas, in response to a disabling state of the blanking interval indicating signal (B), the video signal appears within the displaying interval, which is outside the vertical blanking interval.

According to the requirement specifications, during the vertical blanking interval, the voltage amplitude of the signal received by the video decoder 210 of the TV set 200 is about 300 mV. Therefore, the amplitude of the current outputted from the first digital-to-analog converter (DAC_1) 151 is about 8 mA. In this situation, the voltage amplitude received by the video decoder 210 is 300 mv according to the following formula:

8 mA(Rcvbs/ /Rr)=8 mA×37.5Ω.

Similarly, during the vertical blanking interval, the amplitude of the current outputted from the fourth digital-to-analog converter (DAC_4) 154 is about 8 mA. Since the video output terminal 108 of the Y signal is not connected with the TV set, the voltage amplitude of the signal is 600 mV according to the following formula:

8 mA×Ry=8 mA×75Ω.

In this embodiment, the detector is cyclically enabled. For example, in a case that the detector 160 is enabled for 0.1 second every 2 second, the detecting period is 0.1 second. For example, during the detecting period of the detector 160, according to the control signal E outputted from the detector 160, the CVBS engine 172, the YUV engine 174, the first digital-to-analog converter (DAC_1) 151, the second digital-to-analog converter (DAC_2) 152, the third digital-to-analog converter (DAC_3) 153 and the fourth digital-to-analog converter (DAC_4) 154 are turned on.

During the detecting cycle and during the blanking interval indicating signal (B) is received by the detector 160, the switch control unit 162 will input the CVBS signal or the Y signal into the comparator 164 according to the select signal S. By comparing the inputted video signal (the CVBS signal or the Y signal) with the threshold voltage Vth, the comparator 164 issues the resulting signal to the switch control unit 162. According to the resulting signal, the switch control unit 162 output the control signal E to the first digital-to-analog converter (DAC_1) 151, the second digital-to-analog converter (DAC_2) 152, the third digital-to-analog converter (DAC_3) 153 and the fourth digital-to-analog converter (DAC_4) 154 are turned on. In this embodiment, the threshold voltage Vth is set to be ranged between 300 mV and 600 mV (e.g. 450 mV).

Take the connecting relationship between the multimedia apparatus 100 and the TV set 200 as shown in FIG. 1 for example. The voltage amplitude of the CVBS signal is 300 m, and the voltage amplitude of the Y signal is 600 mV. Meanwhile, the switch control unit 162 realizes that the TV set 200 is receiving the CVBS signal. In this situation, according to the control signal E, the first digital-to-analog converter (DAC_1) 151 and the CVBS engine 172 are turned on, but the YUV engine 174, the second digital-to-analog converter (DAC_2) 152, the third digital-to-analog converter (DAC_3) 153, the fourth digital-to-analog converter (DAC_4) 154 are turned off. Consequently, the controlling circuit 150 stops outputting the YUV, but continuously outputs the CVBS signal.

In a case that the signal line between the video output terminal 102 and the TV set 200 is pulled out and the video output terminals 104, 106 and 108 are connected with the TV set 200 to transmit the YUV signals, the detector 160 realizes that voltage amplitude of the CVBS signal is 600 m and the voltage amplitude of the Y signal is 300 mV during the detecting period. Meanwhile, the switch control unit 162 realizes that the TV set 200 is receiving the YUV signal. In this situation, according to the control signal E, the first digital-to-analog converter (DAC_1) 151 and the CVBS engine 172 are turned off, but the YUV engine 174, the second digital-to-analog converter (DAC_2) 152, the third digital-to-analog converter (DAC_3) 153, the fourth digital-to-analog converter (DAC_4) 154 are turned on. Consequently, the controlling circuit 150 stops outputting the CVBS, but continuously outputs the YUV signal.

In the above embodiment, the video signals outputted from the multimedia apparatus 100 are illustrated by referring to CVBS signals and YUV signals. In some embodiment, the multimedia apparatus can simultaneously output a CVBS signal, a S-Video signal, a YUV signal and a RGB signal. The detector can receive the CVBS signal, a Y signal of the S-Video signal, a Y signal of the YUV signal, a synchronous signal (e.g. G) of the RGB signal and a CVBS signal of a SCART interface. Moreover, during the vertical blanking interval, a voltage amplitude comparison is performed to control a corresponding digital-to-analog converter.

In some embodiment, the multimedia apparatus of the present invention has a single video output terminal for outputting a single analog video signal. In a case that the multimedia apparatus has a single video output terminal, the select signal S and the multiplexer 166 included in the detector of FIG. 1 may be omitted. Under this circumstance, the analog video signal is directly inputted into the comparator 164.

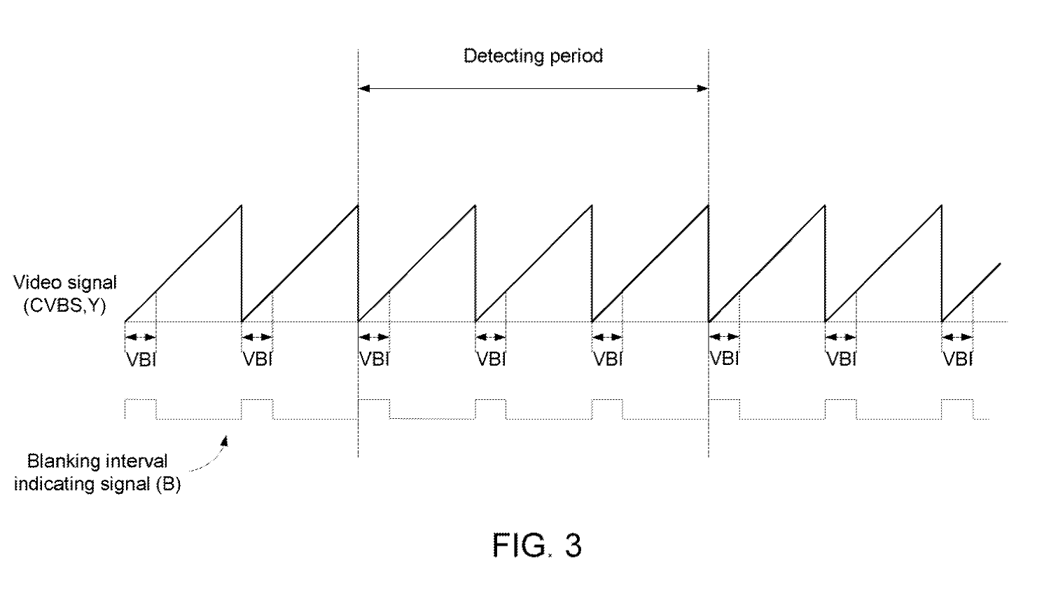

FIG. 3 is a schematic timing waveform diagram illustrating the relationship between the frame of the video signal and the detecting period. In FIG. 3, each triangle denotes a frame of the video signal. The former segment of the each frame denotes the vertical blanking interval (VBI).

During the process of outputting the video signal, the digital video signal generator 170 continuously outputs the blanking interval indicating signal (B). Whereas, the switch control unit 162 detects the video signal only during the detecting period, so that a corresponding DAC and a corresponding video engine are enabled or disabled. Of course, the detector 160 may detect all video signals during a single detecting period. Alternatively, the detector 160 may detect one of the video signals during a single detecting period.

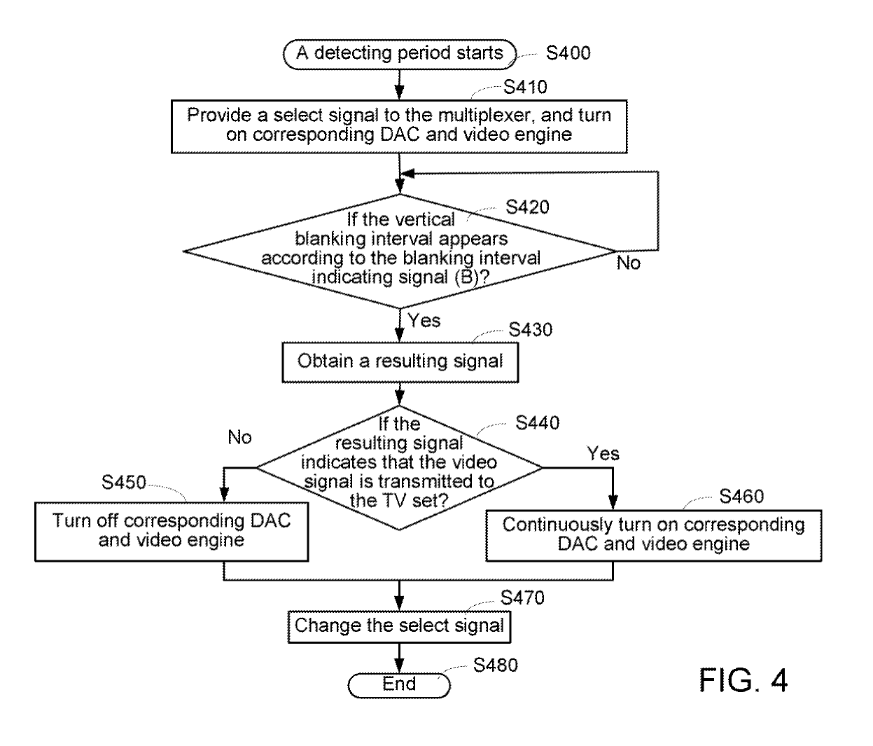

FIG. 4 is a flowchart illustrating a method for detecting video signal connection of a multimedia apparatus according to an embodiment of the present invention. In this embodiment of the detecting method, the switch control unit 162 of the multimedia apparatus 100 of FIG. 1 may only detect one of the video signals during a single detecting period.

When a detecting period starts (Step S400), a select signal S “0” is transmitted to the multiplexer 166, and the first digital-to-analog converter (DAC_1) 151 and the CVBS engine 172 are turned on according to the control signal E (Step S410). Then, the step S420 is perform to judge whether the vertical blanking interval appears according to the blanking interval indicating signal (B) outputted from the digital video signal generator 170. If the vertical blanking interval does not appear, the step S420 is repeatedly done. Whereas, if the vertical blanking interval appears, the resulting signal is retrieved during the vertical blanking interval (Step S430).

Since the CVBS signal is outputted from the multiplexer 166 and the voltage amplitude of the CVBS signal is lower than the threshold voltage Vth, the resulting signal “0” is outputted from the comparator 164. The resulting signal “0” indicates that the CVBS signal is transmitted to the TV set (Step S440). Consequently, the first digital-to-analog converter (DAC_1) 151 and the CVBS engine 172 are continuously turned on (Step S460). Afterwards, the select signal S is changed from “0” to “1” (Step S470), and thus the detecting method is ended (Step S480).

When a next detecting period starts (Step S400), a select signal S “1” is transmitted to the multiplexer 166, and the second digital-to-analog converter (DAC_2) 152 and the YUV engine 174 are turned on according to the control signal E (Step S410). Then, the step S420 is perform to judge whether the vertical blanking interval appears according to the blanking interval indicating signal (B) outputted from the digital video signal generator 170. If the vertical blanking interval does not appear, the step S420 is repeatedly done. Whereas, if the vertical blanking interval appears, the resulting signal is retrieved during the vertical blanking interval (Step S430).

Since the Y signal is outputted from the multiplexer 166 and the voltage amplitude of the Y signal is higher than the threshold voltage Vth, the resulting signal “1” is outputted from the comparator 164. The resulting signal “1” indicates that the Y signal is not transmitted to the TV set (Step S440). Consequently, the second digital-to-analog converter (DAC_2) 152 and the YUV engine 174 are turned off again (Step S450). Afterwards, the select signal S is changed from “1” to “0” (Step S470), and thus the detecting method is ended (Step S480).

On the other hand, if the comparator 164 outputs the resulting signal “0” indicating that the Y signal is transmitted to the TV set, according to the control signal E, the second digital-to-analog converter (DAC_2) 152 and the YUV engine 174 are continuously turned on and the third digital-to-analog converter (DAC_3) 153, the fourth digital-to-analog converter (DAC_4) 154 are turned on again (Step S460).

As can be seen from the detecting method of FIG. 4, if the signal line between the video output terminal 102 and the TV set 200 is pulled out and the video output terminals 104, 106 and 108 are connected with the TV set 200 to transmit the YUV signals, the detector 160 realizes that voltage amplitude of the CVBS signal is 600 m and the voltage amplitude of the Y signal is 300 mV during at least two detecting periods. As a consequence, the detector 160 can judge whether the corresponding DAC and the corresponding video engine are turned on or turned off.

Moreover, for avoiding erroneous judgment of the multimedia apparatus, before the corresponding DAC is turned off (Step S450), a message indicating that the YUV signal fails to be transmitted to the TV set may be shown on the TV set. In addition, the message may be confirmed by the user through a remote controller or a specified key of the multimedia apparatus.

The present invention provides a multimedia apparatus having a function of detecting video signal connection. The video DAC is a current source. The voltage in the no TV-load condition is twice as large as the voltage in the TV-load condition. Since the voltages of most pulses during the vertical blanking interval are fixed, the voltage change during the vertical blanking interval may be used as an index to judge whether any load is connected with the multimedia apparatus. That is, by continuously detecting whether the connecting relationship between the video signal and the TV set is changed, the corresponding DAC is turned on or turned off. Consequently, the power-saving efficacy of the multimedia apparatus is achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multimedia apparatus, comprising:
a first video output terminal to be connected with a display device;
a first resistor interconnected between the first video output terminal and a ground terminal; and
a controlling circuit comprising:
a digital video signal generator for outputting a first digital video signal and a blanking interval indicating signal;
a first digital-to-analog converter for receiving the first digital video signal, wherein the first digital-to-analog converter has a control terminal for receiving a control signal, wherein according to the control signal, the first digital-to-analog converter is enabled to convert the first digital video signal into a first analog video signal and transmit the first analog video signal to the first video output terminal; and
a detector for receiving the first analog video signal, wherein during a detecting period and in response to an enabling state of the blanking interval indicating signal, the detector outputs the control signal to enable the first digital-to-analog converter and compares the first analog video signal with a threshold voltage to obtain a resulting signal, wherein according to the resulting signal, the detector judges whether the first analog video signal is permitted to be transmitted to the display device or not, wherein if the first analog video signal fails to be transmitted to the detector, the first digital-to-analog converter is disabled according to the control signal outputted from the detector, wherein if the first analog video signal is permitted to be transmitted to the display device, the first digital-to-analog converter is enabled according to the control signal outputted from the detector.

2. The multimedia apparatus according to claim 1, wherein the detector is enabled during the detecting period, and the detector comprises:
a switch control unit for receiving the blanking interval indicating signal and outputting the control signal; and
a comparator for receiving the first analog video signal and the threshold voltage, thereby generating the resulting signal,
wherein if the first analog video signal is higher than the threshold voltage, the first analog video signal fails to be transmitted to the detector, wherein if the first analog video signal is lower than the threshold voltage, the first analog video signal is permitted to be transmitted to the detector.

3. The multimedia apparatus according to claim 1, wherein the first analog video signal is a composite video broadcast signal (CVBS), a luminance signal of a S-Video signal or a luminance signal of a YUV signal.

4. The multimedia apparatus according to claim 1, wherein the multimedia apparatus is a game player or a media player.

5. The multimedia apparatus according to claim 1, wherein the display device is a TV set.

6. The multimedia apparatus according to claim 1, wherein the blanking interval indicating signal is outputted from the digital video signal generator during a vertical blanking interval of the first analog video signal.

7. The multimedia apparatus according to claim 1, wherein the detecting period is cyclically generated.

8. The multimedia apparatus according to claim 1, wherein the digital video signal generator further comprises a first video engine having a control terminal for receiving the control signal, wherein according to the control signal, the first video engine is enabled to output the first digital video signal, or the first video engine is disabled to stop outputting the first digital video signal.

9. A multimedia apparatus, comprising:
a first video output terminal to be connected with a display device;
a second video output terminal to be connected with the display device;
a first resistor interconnected between the first video output terminal and a ground terminal; and
a second resistor interconnected between the second video output terminal and the ground terminal; and
a controlling circuit comprising:
a digital video signal generator for outputting a first digital video signal, a second digital video signal and a blanking interval indicating signal;
a first digital-to-analog converter for receiving the first digital video signal, wherein the first digital-to-analog converter has a first control terminal for receiving a control signal, wherein according to the control signal, the first digital-to-analog converter is enabled to convert the first digital video signal into a first analog video signal and transmit the first analog video signal to the first video output terminal, or the first digital-to-analog converter is disabled to stop converting the first digital video signal into the first analog video signal; and
a second digital-to-analog converter for receiving the second digital video signal, wherein the second digital-to-analog converter has a second control terminal for receiving the control signal, wherein according to the control signal, the second digital-to-analog converter is enabled to convert the second digital video signal into a second analog video signal and transmit the second analog video signal to the second video output terminal, or the second digital-to-analog converter is disabled to stop converting the second digital video signal into the second analog video signal;
a detector for receiving the first analog video signal and the second analog video signal, wherein during a detecting period and in response to an enabling state of the blanking interval indicating signal, the detector outputs the control signal to enable the first digital-to-analog converter and compares the first analog video signal with a threshold voltage to obtain a resulting signal, wherein according to the resulting signal, the detector judges whether the first analog video signal is permitted to be transmitted to the display device or not, wherein if the first analog video signal fails to be transmitted to the detector, the first digital-to-analog converter is disabled according to the control signal outputted from the detector, wherein if the first analog video signal is transmitted to the display device again, the first digital-to-analog converter is re-enabled according to the control signal outputted from the detector.

10. The multimedia apparatus according to claim 9, wherein during the detecting period and in response to the enabling state of the blanking interval indicating signal, the detector outputs the control signal to enable the second digital-to-analog converter and compares the second analog video signal with the threshold voltage to obtain the resulting signal, wherein according to the resulting signal, the detector judges whether the second analog video signal is permitted to be transmitted to the display device or not, wherein if the second analog video signal fails to be transmitted to the detector, the second digital-to-analog converter is disabled according to the control signal outputted from the detector, wherein if the second analog video signal is transmitted to the display device again, the second digital-to-analog converter is re-enabled according to the control signal outputted from the detector.

11. The multimedia apparatus according to claim 10, wherein the detector is enabled during the detecting period, and the detector comprises:
a switch control unit for receiving the blanking interval indicating signal, and outputting a select signal and the control signal;
a multiplexer having at least two input terminals for respectively receiving the first analog video signal and the second analog video signal, and a select terminal for receiving the select signal, wherein according to the select signal, the multiplexer selectively outputs either the first analog video signal or the second analog video signal; and
a comparator for receiving an output terminal of the multiplexer and the threshold voltage, thereby generating the resulting signal,
wherein if the first analog video signal is higher than the threshold voltage, the first analog video signal fails to be transmitted to the detector, wherein if the first analog video signal is lower than the threshold voltage, the first analog video signal is permitted to be transmitted to the detector, wherein if the second analog video signal is higher than the threshold voltage, the second analog video signal fails to be transmitted to the detector, wherein if the second analog video signal is lower than the threshold voltage, the second analog video signal is permitted to be transmitted to the detector

12. The multimedia apparatus according to claim 10, wherein the first analog video signal is a composite video broadcast signal (CVBS), a luminance signal of a S-Video signal, a luminance signal of a YUV signal or a synchronous signal of a RGB signal.

13. The multimedia apparatus according to claim 10, wherein the second analog video signal is a composite video broadcast signal (CVBS), a luminance signal of a S-Video signal, a luminance signal of a YUV signal or a synchronous signal of a RGB signal

14. The multimedia apparatus according to claim 9, wherein the multimedia apparatus is a game player or a media player.

15. The multimedia apparatus according to claim 9, wherein the display device is a TV set.

16. The multimedia apparatus according to claim 9, wherein the blanking interval indicating signal is outputted from the digital video signal generator during a vertical blanking interval of the first analog video signal or the second analog video signal.

17. The multimedia apparatus according to claim 9, wherein the detecting period is cyclically generated.

18. The multimedia apparatus according to claim 9, wherein the digital video signal generator further comprises:
a first video engine having a third control terminal for receiving the control signal, wherein according to the control signal, the first video engine is enabled to output the first digital video signal, or the first video engine is disabled to stop outputting the first digital video signal; and
a second video engine having a fourth control terminal for receiving the control signal, wherein according to the control signal, the second video engine is enabled to output the second digital video signal, or the second video engine is disabled to stop outputting the second digital video signal.
